(19) United States
(12) Patent Application Publication
(10) Pub. No.: US 2009/0218322 A1
(43) Pub. Date: Sep. 3, 2009

(54) DIES FOR MANUFACTURING SUBSTRATES AND METHODS OF MAKING

(76) Inventors: David William Folmar, Campbell, NY (US); Mark Lee Humphrey, Elmira, NY (US); Shane David Seyler, Corning, NY (US)

Correspondence Address: CORNING INCORPORATED, SP-TI-3-1, CORNING, NY, 14831, US

(21) Appl. No.: 12/369,173

(22) Filed: Feb. 11, 2009

Related U.S. Application Data
(60) Provisional application No. 61/067,393, filed on Feb. 28, 2008.

(51) Int. Cl. B23H 1/00

(52) U.S. Cl. 219/69.17

(57) ABSTRACT

Extrusion dies for manufacturing substrates with peripheral strengthening are manufactured by plunge EDM machining a solid material and subsequently forming slots by wire EDM slot machining.

### CROSS-REFERENCE TO RELATED APPLICATIONS

This application claims the benefit of priority under 35 U.S.C. §119(e) of U.S. Provisional Application Ser. No. 61/067,393 filed on Feb. 28, 2008.

### FIELD

The present disclosure relates generally to die manufacturing processes, such as XS or IFC plunge EDM machining followed by wire EDM slot machining.

### BACKGROUND

Extrusion dies used for manufacturing substrates with peripheral strengthening, such as XS and IFC, are modified by widening pre-existing slots just inside a skinforming region. A spark erosion process known as electrical discharge machining (EDM) is employed using a formed electrode to widen the slots gradually and to radius pin corners in a desired area of a die. This conventional slot modification method suffers from a number of drawbacks.

Precision alignment of an EDM electrode to a pre-existing slot—such that the XS and IFC modification is centered in the slot—can be difficult due to die and electrode variability. Die variables include slot width, and slot and pin locations. Electrode variables include cell and web size, and cell and web location. These variables produce differing amounts of overcut by the EDM machining process, which results in variable increases in slot width. Slot widths that are greater than or less than targeted design values lead to web width changes in extruded substrates that fail to meet design specifications.

By way of example, FIG. 1 shows that if EDM electrodes 901 are offset, removal of material 903 will be uneven on both sides; i.e., opposing die pins 905 will be of non-uniform dimensions as indicated generally in scenario 907. As scenario 909 shows, if the electrode 901 is further offset from center, removal of material 903 will occur on only one of the die pins 905 and again, the opposing die pins 905 will be non-uniform. If the electrode web 901 is too thin as shown in scenario 911, a gap threshold is not achieved, and no material will be removed. Similarly, as shown in scenario 913, if the slot width is too wide, a gap threshold is not achieved, and no material will be removed.

Efforts to reduce XS and IFC die modification variability have included improving precision of extrusion dies (closer to nominal slot size and slot locations) and plunge EDM electrodes (closer to nominal cell/web size and cell/web locations). These precision improvements, however, add cost and fabrication time to the die manufacturing process.

Another drawback using conventional methods is “sputter” buildup just below an EDM-modified area. Sputter buildup occurs when die material that was eroded during plunge EDM machining re-solidifies and re-attaches to pin sides upon cooling. Sputter that remains on pin sides through the die manufacturing process ends up being coated over. Since sputter is in the batch flow path, it negatively affects substrate forming during extrusion by producing defects such as missing webs, non-knitters, and the like that cause otherwise good dies to be scrapped, thereby increasing costs.

Efforts to prevent sputter buildup have included changing plunge EDM processes to affect dielectric flushing, but sputter is still evident to varying degrees. Machine parameters have also been modified to “soften” erosion effects, but still sputter is produced while erosion time is increased. Dies have also been nickel plated before EDM plunging to act as barrier coating, but the die must be stripped after plunging to remove remnant sputter and nickel, which adds manufacturing steps and increases fabrication complexity. Slots may also be hand shimmed, which may remove sputter to varying degrees; however, hand shimming is an inexact, labor-intensive process.

### BRIEF SUMMARY

The present disclosure provides a die manufacturing process that is economical and avoids the problems of sputter build-up, die variabilities, and attendant material waste. Various methods of manufacturing dies are described, using plunge EDM machining, which produces a consistent and predictable overcut, followed by slot machining, preferably by wire slot machining. Since pre-existing slots are not present before the plunge EDM machining, as in previous approaches, sputter buildup does not occur.

In an exemplary embodiment, a method of manufacturing extrusion dies having slot widths free of sputter includes: providing a die blank; plunging an EDM electrode into a first portion of the face of the die blank to form one or more die pins having respective EDM plunge slots formed inbetween the die pins; and slot machining one or more slots—using, for example, a wire EDM slot machine—into a second portion of the face of the die blank near or adjacent to the EDM plunge slots. In some instances, the first portion may surround the second portion. In this example, the EDM electrode is complementary shaped to form a section or portion of the die pins.

The step of plunging the EDM electrode into the face of the die blank may create a die pin pattern of the die pins. Such a pattern may be achieved by plunging the EDM electrode into the face to produce a first cut and then rotating and subsequently plunging the EDM electrode to form additional cuts necessary to complete the desired die pin pattern of the die pins. The method may further include slot machining a plurality of transverse slots near or adjacent to the EDM plunge slots.

In another particular embodiment, a method of manufacturing extrusion dies having uniform slot widths free of sputter may include: providing a die blank; plunging an EDM electrode into a first portion of the face of the die blank to form a plurality of die pins having respective EDM plunge slots formed therebetween; slot machining a plurality of first slots into the face of the die blank proximate to the EDM plunge slots; and slot machining a plurality of second slots into the face of the die blank proximate to the EDM plunge slots, such second slots preferably being oriented perpendicularly to the first machined slots. In this aspect of the disclosure, the EDM electrode is complementary shaped to form a group or portion of the die pins. The method may further include repeatedly plunging the EDM electrode to form a die pin pattern of the die pins, as described above.

In yet a further embodiment, a method of manufacturing extrusion dies having uniform slot widths free of sputter includes providing a die blank; plunging an EDM electrode into a first portion of the face of the die blank to form a plurality of die pins having respective EDM plunged slots formed therebetween; machining, using a wire EDM slot machine, a plurality of first slots into the face of the die blank proximate to the EDM plunge slots; and machining, using the wire EDM slot machine, a plurality of second slots into the face of the die blank proximate to the EDM plunge slots.

In this aspect, the EDM electrode is complementary shaped to form a portion of the die pins. The method may further include rotating and plunging the EDM electrode at least three times to form a die pin pattern of the die pins.

Evident from the foregoing introduction, the die manufacturing processes and resultant dies are simple and economical to manufacture. Other advantages of the disclosure will be apparent from the following description and the attached drawings or can be learned from practice of the disclosure.

It is to be understood that both the foregoing general description and the following detailed description present embodiments of the disclosure, and are intended to provide an overview or framework for understanding the nature and character of the disclosure as it is claimed. The accompanying drawings are included to provide a further understanding of the disclosure and are incorporated into and constitute a part of this specification. The drawings illustrate various embodiments of the disclosure and together with the description serve to explain the principles and operations of the disclosure.

### BRIEF DESCRIPTION OF THE DRAWINGS

The foregoing and other features, aspects and advantages of the present disclosure may be better understood when the following detailed description is read with reference to the accompanying drawings, in which:

FIG. 1 is a schematic plan view of a conventional die manufacturing process;

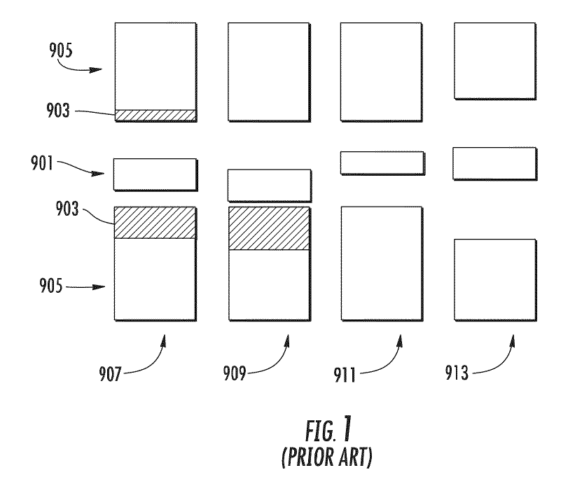

FIG. 2 is top perspective view of a fabricated die according to an embodiment of the disclosure;

FIG. 3 is a top perspective view showing exemplary steps of fabricating the die as in FIG. 2;

FIG. 4 is a top perspective view showing a die pin pattern as in FIG. 2;

FIG. 5 is a top perspective view showing a further exemplary step of fabricating the die, particularly showing an enlarged view of the die pin pattern as in FIG. 2; and

FIG. 6 is a top perspective view showing a further exemplary step of fabricating the die as in FIG. 2, particularly showing an enlarged view of the die pin pattern.

### DETAILED DESCRIPTION

The present disclosure will now be described more fully hereinafter with reference to the accompanying drawings in which exemplary embodiments of the disclosure are shown. However, aspects of this disclosure may be embodied in many different forms and should not be construed as limited to the embodiments set forth herein. These exemplary embodiments are provided so that this disclosure will be both thorough and complete, and will fully convey the scope of the disclosure to those skilled in the art. Whenever possible, like reference numerals will be used throughout the detailed description of the disclosure to refer to like or similar elements of the various drawings.

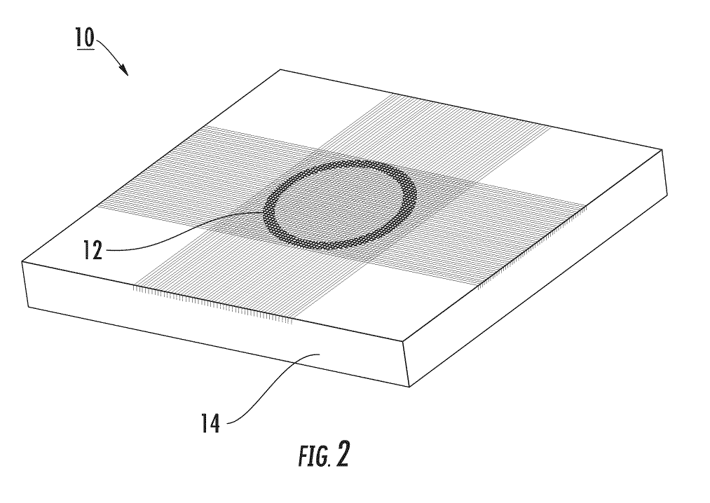

Turning now to the figures, various embodiments of dies and exemplary methods of manufacturing die pin patterns are shown generally in FIGS. 2-6.

With particular reference to FIG. 2, a completed die pin fabrication or fabricated die is broadly designated by the element number 10. As shown, a die pin pattern 12 is machined initially by plunge EDM machining a first portion of a face of a solid die blank 14 that has no pre-existing slots. The die blank 14 is next machined, for example, by wire EDM slot machining, as described in detail below.

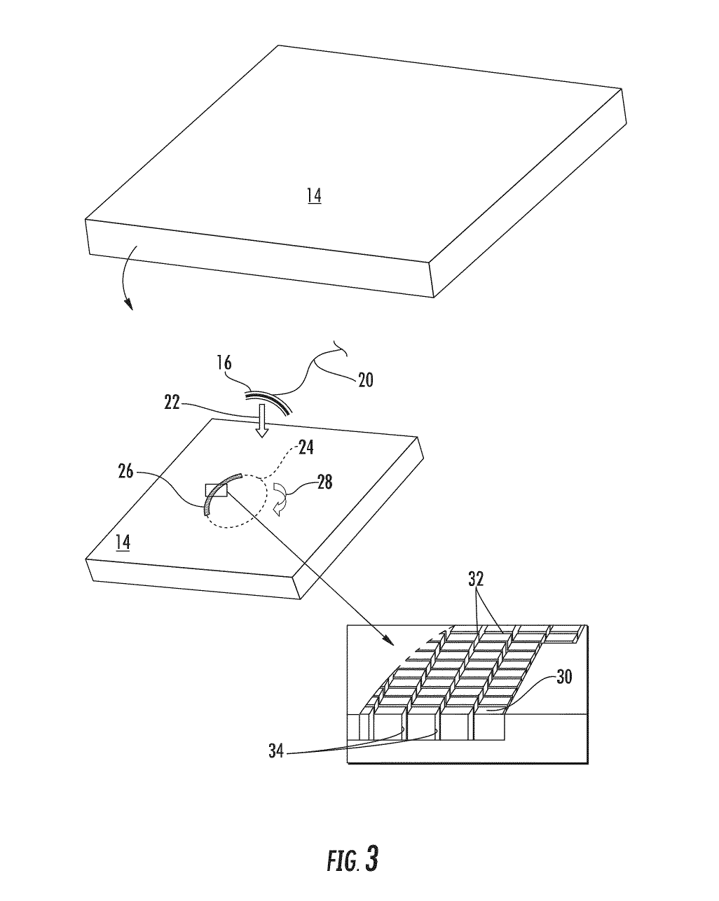

With reference to FIG. 3, the die blank 14 briefly introduced above may be fabricated from a machineable or shapeable solid material having good wear resistance and strength adequate to withstand the normal forces of extrusion. Examples of such suitable materials include machineable steel materials (including ferritic, austenitic and/or martensitic tool steels), hardenable tool steels, carbon steel, stainless steels (such as types 450 stainless steel and 422 stainless steel), and other steel alloys. The die blank 14, or parts thereof, may be hardened for higher yield strength after machining. The die blank 14 undergoes plunge EDM machining using a plunge EDM electrode 16 that is connected to a power source 20. As shown, the plunge EDM electrode 16 is plunged in a direction 22 onto a pattern area 24, such as a halo pattern, depicted on the die blank 14. A first cut or pattern (also referred to as a ¼ pattern) 26 is made, and the plunge EDM electrode 16 is then retracted and rotated in a rotation direction 28 for subsequent plunging.

FIG. 3 particularly shows in an enlargement of the first cut 26 that produced a plurality of die pins 30 that have a plurality of respective EDM plunge slots 32 formed therebetween. Also shown, the pins 30 have rounded pin corners 34 in the plunge EDM area.

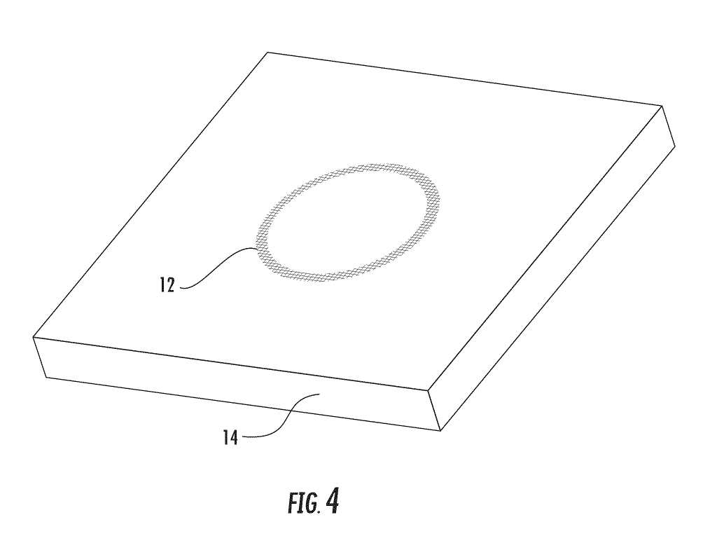

With reference now to FIG. 4, once the pattern area 24 of FIG. 3 has been completely plunged, a complete plunge die pin pattern 12 is formed in the die blank 14. Those skilled in the art of plunge cutting will appreciate that the electrode 16 can be shaped differently to suit specific die manufacturing requirements and is not limited to forming the exemplary ¼ pattern 26 or the particular halo pattern shown.

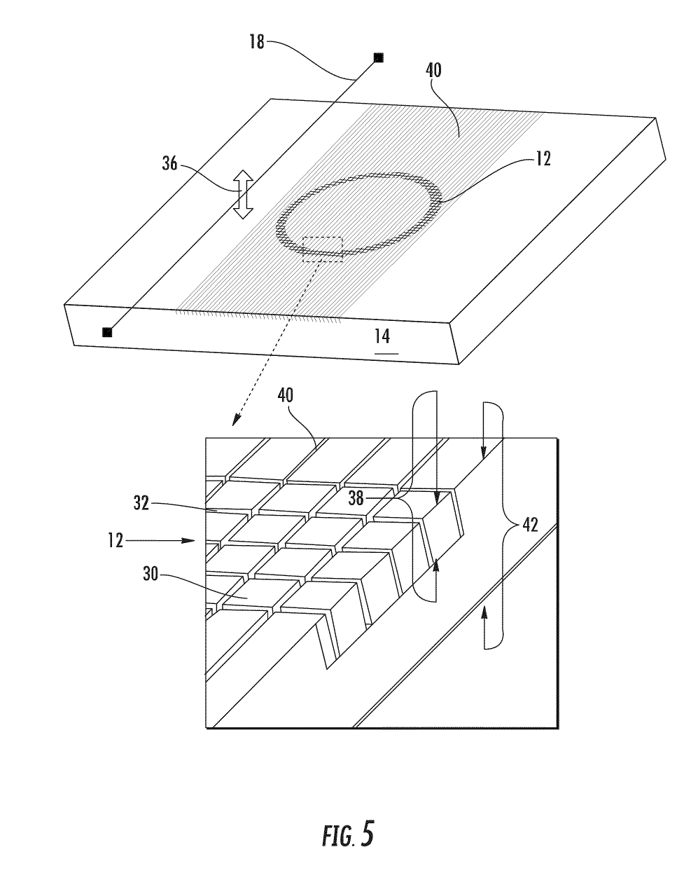

FIG. 5 shows the die blank 14 having die pin pattern 12 that has been subjected to slot machining—for example, to wire EDM machining by a schematically depicted wire EDM 18. As shown, the wire EDM 18 is applied in an application direction 36 to form a plurality of first wire EDM slots 40 that, in this example, are transverse to the EDM plunge slots 32 introduced above. For clarity, only a limited number of wire EDM slots 40 are shown, although in practice it will be understood that many more slots 40 will likely be formed. As shown, in detail, the first wire EDM slots 40 are formed about the pins 30 to create respective plunge EDM depths 38 about each of the pins 30. Moreover, the wire EDM 18 has formed wire EDM slot depths 42 as shown.

In one embodiment, EDM plunge slots 32 and (wire) EDM slots 40 have approximately the same width (that is, the slots may be said to have uniform width). Alternately, EDM plunge slots 32 may be said to have a first width, and (wire) EDM slots 40, a second width, where the second width is less than the first width. In either case, it may be desirable that the width of the EDM plunge slots 32 remain unchanged after formation of the wire EDM slots 40.

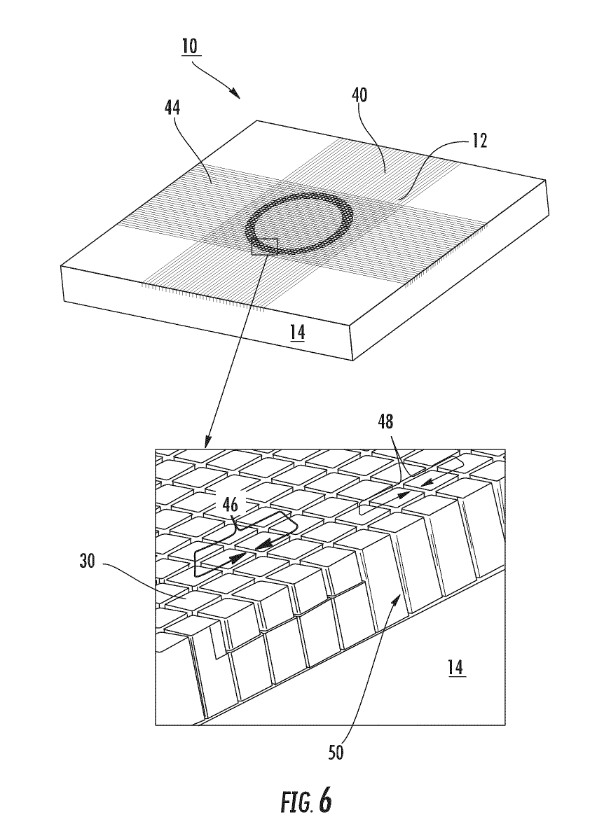

Turning now to FIG. 6, the completed die pin fabrication 10 is shown by which the wire EDM 18 of FIG. 5 has been rotated, preferably perpendicularly, to form a plurality of second wire EDM slots 44 through and about the die pin pattern 12. More particularly, a slot width plunge area 46 is shown in the wire EDM area. Also shown, the slot width 48 is formed in the wire EDM area. A plurality of square pin corners 50 are also shown in the wire EDM area.

Although reference has been made throughout this disclosure to the formation of the first and second slots by slot machining or wire EDM machining, it is contemplated that plunge EDM machining may be used in place of one of these methods. Thus, the method may include plunge EDM machining of the die pins 30, followed by plunge EDM machining of slots 40 and/or 44.

As shown and described above by way of example, sputter buildup below EDM modified areas is avoided by plunge EDM machining a solid material before wire EDM machining slots. Surprisingly and advantageously, this modification in the sequence of machining—that is, plunge EDM machining before wire (or slot) EDM machining—effectively prevents eroded die material from reattaching to the pin sides on cool-down. Accordingly, the embodiments described herein and their equivalents avoid defects in extruded substrates, such as missing webs, non-knitters, and the like caused by the prior practice of plunge EDM machining after slot formation.

Although examples have been described in such a way as to provide an enabling disclosure for one skilled in the art to make and use the embodiments and their equivalents according to the disclosure, it should be understood that the descriptive examples are not intended to limit the disclosure to use only as shown in the figures. It is intended to claim all such changes and modifications as fall within the scope of the appended claims and their equivalents. Thus, while exemplary embodiments of the disclosure have been shown and described, those skilled in the art will recognize that changes and modifications may be made to the foregoing examples without departing from the scope and spirit of the disclosure. Moreover, although specific terms are employed herein, they are used in a generic and descriptive sense only and not for purposes of limitation.

That which is claimed is:

1. A method of manufacturing extrusion dies, the method comprising:
providing a die blank;
forming a first plurality of slots and die pins in a first portion of a face of the die blank by plunging an EDM electrode into the die blank, each of the slots having a first width; and
forming a second plurality of slots and die pins in a second portion of the face proximate to the first plurality of slots, wherein each of the second plurality of slots has a second width, the second width being less than the first width.

2. The method of claim 1, wherein the step of forming the second plurality of slots and die pins in the face of the die blank comprises one of plunging an EDM electrode into the die blank and wire EDM machining.

3. The method of claim 1, wherein the first plurality of slots are free of sputter.

4. The method of claim 1, wherein the first portion surrounds the second portion.

5. The method of claim 1, wherein the first width is unchanged during forming the second plurality of slots and pins in the second portion.

6. The method of claim 1, wherein the EDM electrode has a shape that is complementary to a portion of the die pins.

7. The method of claim 1, wherein the step of forming the first plurality of slots and die pins comprises rotating at least one of the EDM electrode and the die blank with respect to each other to form a pattern of the first plurality of slots and die pins.

8. A method of manufacturing extrusion dies having uniform slot widths free of sputter, the method comprising:
providing a die blank;
plunging an EDM electrode into a face of the die blank to form a plurality of die pins having respective EDM machined slots formed therebetween;
slot machining a plurality of first slots into the face proximate to the EDM machined slots; and
slot machining a plurality of second slots into the face proximate to the EDM machined slots and perpendicular to the first slots.

9. The method of claim 8, wherein the EDM electrode has a shape that is complementary to a portion of the die pins.

10. The method of claim 8, further comprising subsequently plunging the EDM electrode to form a die pin pattern of the die pins.

11. The method of claim 8, wherein a wire EDM slot machine is used for the slot machining.

12. A method of manufacturing extrusion dies having uniform slot widths free of sputter, the method comprising:
providing a die blank;
plunging an EDM electrode into a face of the die blank to form a plurality of die pins having respective EDM machined slots formed therebetween;
machining a plurality of first slots into the face proximate to the EDM machined slots using a wire EDM slot machine; and
machining a plurality of second slots into the face proximate to the EDM machined slots using the wire EDM slot machine.

13. The method of claim 12, wherein the EDM electrode has a shape that is complementary to a portion of the die pins.

14. The method of claim 12, wherein plunging an EDM electrode into the face of the die blank to form the plurality of die pins forms a die pin pattern.

15. The method of claim 12, further comprising rotating at least one of the EDM electrode and the die blank with respect to each other to form a pattern of slots and die pins.
